(19) United States
(12) Patent Application Publication
(10) Pub. No.: US 2020/0202303 A1
(43) Pub. Date: Jun. 25, 2020

(54) RELEVANCE SCORES FOR USER ACCOUNTS

(71) Applicant: Microsoft Technology Licensing, LLC, Redmond, WA (US)

(72) Inventors: Chong Zhang, Mountain View, CA (US); Li Zhou, Sunnyvale, CA (US); Andrew Walter Chimka, San Francisco, CA (US); Kevin Chuang, San Francisco, CA (US); Kumaresh Pattabiraman, Sunnyvale, CA (US); Yixiao Lu, Sunnyvale, CA (US); Nadeem Anjum, Santa Clara, CA (US); George Pearman, Menlo Park, CA (US); Hsiang Lin, Sunnyvale, CA (US)

(21) Appl. No.: 16/230,079

(22) Filed: Dec. 21, 2018

(51) Int. Cl. G06Q 10/10; G06F 16/33; G06F 16/29; H04L 29/08

(52) U.S. Cl. CPC G06Q 10/1053; H04L 67/306; G06F 16/29; G06F 16/3334

(57) ABSTRACT

Disclosed are systems, methods, and non-transitory computer-readable media for identifying profiles in a network based on relevance scores. A relevancy system identifies a set of candidate user profiles based on user profiles that correspond to users that are members of a first organization. For each candidate user profile, the relevancy system determines scores indicating a relevance level of the respective candidate user profile to an employment listing based on multiple relevance categories. The relevancy system applies weights to the scores and determined a relevance score for the candidate user profile based on the weighted relevancy scores. The weighs are determined based on historical hiring data and indicate a relative impact of each relevance category on hiring. The relevancy system selects a subset of the candidate user profiles based on the relevance scores and transmits notifications regarding the employment listing to the subset of the candidate user profiles.

### TECHNICAL FIELD

An embodiment of the present subject matter relates generally to profiles in a network and, more specifically, to identifying profiles in a network based on relevance scores.

### BACKGROUND

Online networking services allow users to connect with other users for different types of networking. For example, users create user profiles that list the users' experience, interests, etc. The completed user profiles can be used to learn about the users, which is helpful in finding candidates for open employment listings. The number of profiles and users of social networking service may be in the billions. The task of reviewing profiles for qualified candidates is daunting and requires significant resources. Accordingly, improvements are needed.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 shows an example system configuration, wherein electronic devices communicate via a network for purposes of exchanging content and other data.

FIG. 2 is a block diagram of the relevance system, according to some example embodiments.

FIG. 3 is a flowchart showing an example method of identifying a set of candidate user profiles, according to certain example embodiments.

FIG. 4 is a flowchart showing an example method of identifying a set of relevant user profiles, according to certain example embodiments.

FIG. 5 is a flowchart showing an example method of determining a relevance score for a candidate user profile, according to certain example embodiments.

FIG. 6 is a block diagram illustrating a representative software architecture, which may be used in conjunction with various hardware architectures herein described.

FIG. 7 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

In the following description, for purposes of explanation, various details are set forth in order to provide a thorough understanding of some example embodiments. It will be apparent, however, to one skilled in the art, that the present subject matter may be practiced without these specific details, or with slight alterations.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

Disclosed are systems, methods, and non-transitory computer-readable media for identifying profiles in a network based on relevance scores. A relevance system identifies relevant user profiles for a given listing or defined set of parameters. An employment listing is a description for an open job position with an organization. The relevance system initially leverages the connections of the current employees of the organization. For example, the relevance system identifies a set of candidate user profiles based on the connections of the employees of the organization (e.g., 1^{st} degree connections, 2^{nd} degree connections, etc.). Leveraging the connections of current employees provides a set of candidates that have an existing connection to the organization, which may increase the likelihood of filling the open position.

Once a set of candidate user profiles has been identified, the relevance system determines relevance scores for the candidate user profiles. The relevance score indicates an estimated relevance between the candidate user profile and the open employment listing. That is, the relevance score indicates how relevant the open position may be to the user and how well the user fits the qualifications of the open position. The relevance system determines the relevance scores based on individual scores determined for various relevance categories. Each relevance category is a unique predetermined signal for determining relevance between a candidate user profile and an open employment position. For example, a relevance category can be based on title and the corresponding score indicates how well the title of the employment listing matches the user profile. As another example, a relevance category may be based on location and the corresponding score indicates how well a location of the employment listing matches a location of the user. As another example, a relevance category may be based on skills and the corresponding score indicates how well the desired skills of the open position matches the listed skills of the user.

The relevance system determines the individual scores for each relevance category based on data included in the candidate user profile and the employment listing. For example, the relevance system uses terms (e.g., words) included in the candidate user profile and the employment listing. The relevance system utilizes a subset of the terms in the employment listing based on the respective relevance category. For example, to determine a score for a relevance category based on title, the relevancy system uses to included in the title of the employment listing and terms included in the user's job title history listed on their user profile. As another example, the relevance system determines the score for a relevancy category based on skills using terms included in the candidate user profile the list the user's skills and terms in the employment listing desired skills for the open position.

In some embodiments, the relevancy system determines the score for each relevance category by matching terms from the candidate user profile and the employment listing. For example, the relevancy system assigns a higher score when a relatively high number of the terms match, whereas the relevancy system assigns a lower score when a relatively lower number of the terms match. In some embodiments, the relevancy system determines the score based on a determined distance, such as a distance between the location listed on the candidate user's profile to a location listed on the employment listing. For example, the relevancy system assigns a higher score when the distance is relatively shorter, whereas the relevancy system assigns a lower score when the distance is relatively longer.

The relevancy system determines the relevancy score based on the individual scores for each relevancy category. For example, the relevancy system determines the relevancy score by determining a sum of the individual scores for the relevancy categories. As another example, the relevancy system determines the relevancy score by determining an average of the individual scores.

In some embodiments, the relevancy system applies weights to the individual scores based on the estimated impact of their corresponding relevancy category to successfully finding a candidate to fill an open employment position. That is, the relevancy system gives more consideration to relevancy categories that are determined to have a higher estimated impact on filling an employment position, and the relevancy system gives less consideration to relevancy categories that are determined to have a lower estimated impact on filling an employment position.

The relevancy system determines the weights for each relevancy category based on historical hiring data. Historical hiring data includes previous employment listings and user profiles of users that were considered and/or filled the previous employment listings. The relevancy system uses the historical hiring data and a set of relevancy categories as training data to generate a model that generates weights for each of the relevancy categories.

The relevancy system uses the relevancy scores determined for the candidate user profiles to select a subset of the candidate user profiles, to which notifications regarding the employment listing can be sent. For example, the relevancy system can rank the candidate user profiles based on the relevancy scores and select a subset of the candidate user profiles that are ranked the highest, such as the top 10, 20, 30, etc., candidate user profiles. As another example, the relevancy system identifies a subset of the candidate user profiles that have a relevancy score above a threshold relevancy score.

Using the relevancy scores to identify a subset of the candidate user profiles greatly reduces the resources used during the candidate identification process. For one, a recruiter no longer has to manually review a high number of user profiles to identify qualified candidates. Further, by identifying relevant user profiles, the number of notifications transmitted is greatly reduced, thereby reducing computing resources.

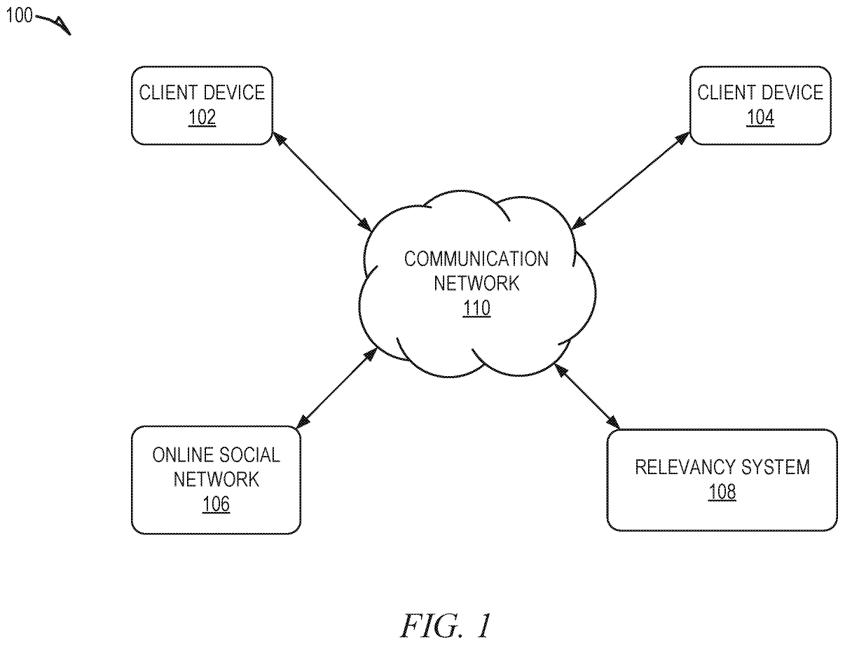

FIG. 1 shows an example system 100, wherein electronic devices communicate via a network for purposes of exchanging content and other data. As shown, multiple devices (i.e., client device 102, client device 104, online social network 106, and relevancy system 108) are connected to a communication network 110 and configured to communicate with each other through use of the communication network 110. The communication network 110 is any type of network, including a local area network (LAN), such as an intranet, a wide area network (WAN), such as the internet, or any combination thereof. Further, the communication network 110 may be a public network, a private network, or a combination thereof. The communication network 110 is implemented using any number of communication links associated with one or more service providers, including one or more wired communication links, one or more wireless communication links, or any combination thereof. Additionally, the communication network 110 is configured to support the transmission of data formatted using any number of protocols.

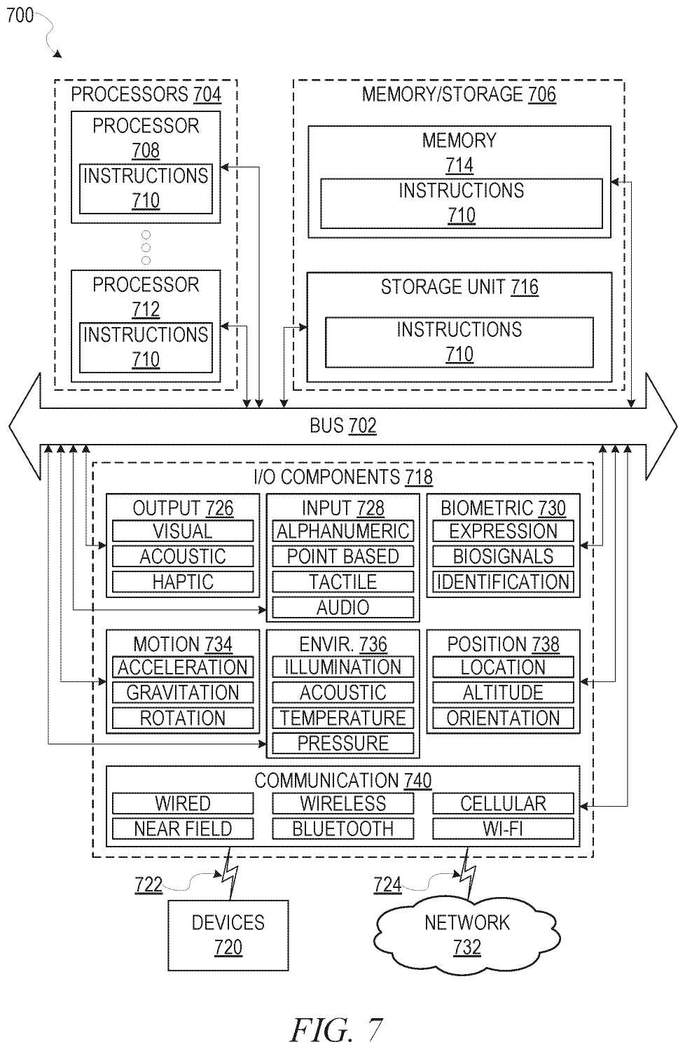

Multiple computing devices can be connected to the communication network 110. A computing device is any type of general computing device capable of network communication with other computing devices. For example, a computing device can be a personal computing device such as a desktop or workstation, a business server, or a portable computing device, such as a laptop, smart phone, or a tablet personal computer (PC). A computing device can include some or all of the features, components, and peripherals of the machine 700 shown in FIG. 7.

To facilitate communication with other computing devices, a computing device includes a communication interface configured to receive a communication, such as a request, data, and the like, from another computing device in network communication with the computing device and pass the communication along to an appropriate module running on the computing device. The communication interface also sends a communication to another computing device in network communication with the computing device.

In the system 100, users interact with the online social network 106 to utilize the services provided by the online social network 106. Users communicate with and utilize the functionality of the online social network 106 by using the client devices 102 and 104 that are connected to the communication network 110 by direct and/or indirect communication.

Although the shown system 100 includes only two client devices 102, 104, this is only for ease of explanation and is not meant to be limiting. One skilled in the art would appreciate that the system 100 can include any number of client devices 102, 104. Further, the online social network 106 may concurrently accept connections from and interact with any number of client devices 102, 104. The online social network 106 supports connections from a variety of different types of client devices 102, 104, such as desktop computers; mobile computers; mobile communications devices, e.g., mobile phones, smart phones, tablets; smart televisions; set-top boxes; and/or any other network enabled computing devices. Hence, the client devices 102 and 104 may be of varying type, capabilities, operating systems, and so forth.

A user interacts with the online social network 106 via a client-side application installed on the client devices 102 and 104. In some embodiments, the client-side application includes a component specific to the online social network 106. For example, the component may be a stand-alone application, one or more application plug-ins, and/or a browser extension. However, the users may also interact with the online social network 106 via a third-party application, such as a web browser, that resides on the client devices 102 and 104 and is configured to communicate with the online social network 106. In either case, the client-side application presents a user interface (UI) for the user to interact with the online social network 106. For example, the user interacts with the online social network 106 via a client-side application integrated with the file system or via a webpage displayed using a web browser application.

The online social network 106 is one or more computing devices configured to provide a social networking service. The online social network 106 may provide any type of social networking service that allows a user to create a user profile, view the user profiles of other users, make connections with other user profiles, post content and view content posted by other users. An example of a social networking service is LINKEDIN.

A user may include information describing themselves in their user profile with the online social network 106. For example, the user may include information such as their name, interests, location, job history, skills, goals (e.g., looking to find new opportunities) etc.

A user may also establish connections with other users on the online social network 106. For example, the user may send and receive connection request to establish a connection with another user profile. Establishing connections allows users to view their connection's user profiles and content posted by their connections.

As part of its provided service, the online social network 106 allows organizations (e.g., companies) to post employment listing for open positions with the organization. An employment listing is a description of an available job at the organization. The employment listing may include the title of the open employment position (e.g., software programmer, project manager, etc.), a description of the responsibilities of the employment position, a description of desired skills of an applicant, a geographic location of the employment position, a salary range, etc.

The online social network 106 provides notifications to relevant user profiles about a posted employment listing. A user profile is determined to be relevant to an employment listing when the corresponding user is determined to be a good fit for the employment position and/or the employment position is determined to be a good fit for the user. The online social network 106 uses the functionality of a relevance system 108 to identify user profiles that are relevant. Although the relevance system 108 and the online social network 106 are shown as separate entities, this is just one embodiments and is not meant to be limiting. In some embodiments, the relevance system 108 may be incorporated as part of the online social network 106.

The relevance system 108 is one or more computing device configured to identify relevant user profiles for a given employment listing. An employment listing is a description for an open job position with an organization. The relevance system 108 initially leverages the connections of the current employees of the organization. For example, the relevance system 108 identifies a set of candidate user profiles based on the connections of the employees of the organization (e.g., 1st degree connections, 2^{nd} degree connections, etc.). Leveraging the connections of current employees provides a set of candidate users that have an existing connection to the organization, which may increase the likelihood of filling the employment position.

Once a set of candidate user profiles has been identified, the relevance system 108 determines relevance scores for the candidate user profiles. Each relevance score indicates an estimated relevance between a candidate user profile and the open employment listing. That is, the relevance score indicates how relevant the open position may be to the user and how well the user fits the qualifications of the open position. The relevance system 108 determines the relevance scores based on individual scores determined for various relevance categories. Each relevance category is a unique predetermined signal for determining relevance between a candidate and an open employment position. For example, a relevance category can be based on title and the corresponding score indicates how well the title of the employment listing matches the user profile. As another example, a relevance category may be based on location and the corresponding score indicates how well a location of the employment listing matches a location of the user. As another example, a relevance category may be based on skills and the corresponding score indicates how well the desired skills of the open position matches the listed skills of the user.

The relevance system 108 determines the individual scores for each relevance category based on data included in the candidate user profile and the employment listing. For example, the relevance system 108 uses terms (e.g., words) included in the candidate user profile and the employment listing. The relevance system 108 utilizes a subset of the terms in the employment listing based on the respective relevance category. For example, to determine a score for a relevance category based on title, the relevancy system uses terms included in the title of the employment listing and terms included in the user's job title history listed on their user profile. As another example, the relevance system determines the score for a relevancy category based on skills using terms included in the candidate user profile the list the user's skills and terms in the employment listing desired skills for the open position.

In some embodiments, the relevancy system 108 determines the score for each relevance category by matching terms from the candidate user profile and the employment listing. For example, the relevancy system 108 assigns a higher score when a relatively high number of the terms match, whereas the relevancy system 108 assigns a lower score when a relatively lower number of the terms match. In some embodiments, the relevancy system 108 determines the score based on a determined distance, such as a distance between the location listed on the candidate user's profile to a location listed on the employment listing. For example, the relevancy system 108 assigns a higher score when the distance is relatively shorter, whereas the relevancy system 108 assigns a lower score when the distance is relatively longer.

The relevancy system 108 determines the relevancy score based on the individual scores for each relevancy category. For example, the relevancy system 108 determines the relevancy score by determining a sum of the individual scores for the relevancy categories. As another example, the relevancy system 108 determines the relevancy score by determining an average of the individual scores.

In some embodiments, the relevancy system 108 applies weights to the individual scores based on the estimated impact of their corresponding relevancy category to successfully finding a candidate to fill an open employment position. That is, the relevancy system 108 gives more consideration to relevancy categories that are determined to have a higher estimated impact on filling an employment position, and the relevancy system 108 gives less consideration to relevancy categories that are determined to have a lower estimated impact on filling an employment position.

The relevancy system 108 determines the weights for each relevancy category based on historical hiring data. Historical hiring data includes previous employment listings and user profiles of users that were considered and/or filled the previous employment listings. The relevancy system 108 uses the historical hiring data and a set of relevancy categories as training data to generate a model that generates weights for each of the relevancy categories.

The relevancy system 108 uses the relevancy scores determined for the candidate user profiles to select a subset of the candidate user profiles, to which notifications regarding the employment listing can be sent. For example, the relevancy system 108 can rank the candidate user profiles based on the relevancy scores and select a subset of the candidate user profiles that are ranked the highest, such as the top 10, 20, 30, etc., candidate user profiles. As another example, the relevancy system 108 identifies a subset of the candidate user profiles that have a relevancy score above a threshold relevancy score.

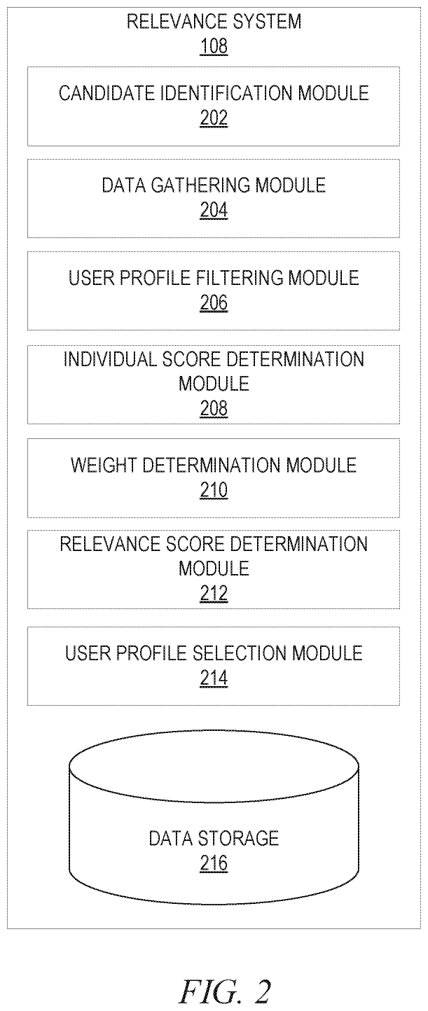

FIG. 2 is a block diagram of the relevancy system 108, according to some example embodiments. To avoid obscuring the inventive subject matter with unnecessary detail, various functional components (e.g., modules) that are not germane to conveying an understanding of the inventive subject matter have been omitted from FIG. 2. However, a skilled artisan will readily recognize that various additional functional components may be supported by the relevancy system 108 to facilitate additional functionality that is not specifically described herein. Furthermore, the various functional modules depicted in FIG. 2 may reside on a single computing device or may be distributed across several computing devices in various arrangements such as those used in cloud-based architectures. For example, the various functional modules and components may be distributed amongst computing devices that facilitate both the relevancy system 108 and the online social network 106.

As shown, the relevance system 108 includes a candidate identification module 202, a data gathering module 204, a user profile filtering module 206, an individual score determination module 208, a weight determination module 210, a relevance score determination module 212, a user profile selection module 214, and a data storage 216.

The candidate identification module 202 identifies a set of candidate user profiles for a given employment listing. The candidate identification module 202 leverages the existing connections of the employees of an organization to identify the set of candidate user profiles. For example, the candidate identification module 202 first identifies the organization associated with the employment listing from the content of the employment listing and then uses the identified organization to identify a set of user profiles corresponding to users that are members of the organization (e.g., employees of the organization). The data storage 216 maintains the user profiles and the candidate identification module 202 searches the data storage 216 based on the identified organization to identify that set of user profiles that are members of the organization.

The candidate identification module 202 identifies the set of candidate user profiles based on the connections of the set of user profiles corresponding to the members of the organization. That is, the candidate identification module 202 identifies user profiles that are within a threshold degree of connection with the set of user profiles corresponding to the members of the organization. For example, the candidate identification module 202 identifies user profiles that are within one degree of connection of the set of candidate user profiles. As another example, the candidate identification module 202 identifies user profiles that are within two degrees of connection of the set of candidate user profiles.

The candidate identification module 202 may further filter the identified user profiles to remove user profiles that are already members of the organization. As a result, the set of candidate user profiles includes user profiles for users that are not member of organization and that are within a threshold degree of connection with existing members of the organization.

The data gathering module 204 gathers data used to generate relevance scores for the candidate user profiles. The data gathering module 204 gathers data from the candidate user profiles as well as from the employment listing. For example, the data gathering module 204 communicates with the data storage 216 to gather the candidate user profiles and the employment listing. The data gathering module 204 may gather and provide all or subsets of the data included in the candidate user profiles and the employment listing to the other modules of the relevance system 108.

The user profile filtering module 206 filters the set of candidate profiles to remove candidate user profiles of users that are determined to be unlikely to be interested in the employment listing. For example, the user profile filtering module 206 may filter the candidate user profiles to remove user profiles that include data indicating that the user is not interested in new employment opportunities. As another example, the user profile filtering module 206 filters candidate user profiles based on location. For example, the user profile filtering module 206 filters candidate user profiles for users that are geographically located more than a threshold distance from a geographic location from a geographic location listed in the employment listing. As another example, the user profile filtering module 206 filters candidate user profiles that are geographically located in a different region than the geographic region listed in the employment listing, such as candidate user profiles for users located in a different country, state, etc.

There are just a few examples of how the user profile filtering module 206 may filter the candidate user profiles and are not meant to be limiting. The user profile filtering module 206 may filter the candidate user profiles based on any other factors. Further, in some embodiments, the relevancy system 108 may not filter any of the candidate user profiles.

The individual score determination module 208 determines a set of individual scores for a candidate user profile based on a set of relevance categories. A relevance category is a unique predetermined signal for determining relevance between a candidate user profile and an open employment position. For example, a relevance category can be based on the title of the employment listing and the corresponding individual score indicates how well the title of the employment listing matches the job titles included in the employment history of the candidate user profile. As another example, a relevance category may be based on the location of the employment history and the corresponding individual score indicates how well the location of the employment listing matches a location of the user corresponding to the candidate user profile. As another example, a relevance category may be based on the desired skills listed in the employment listing and the corresponding individual score indicates how well the desired skills of the employment matches the listed skills of the user corresponding to the candidate user profile.

The individual score determination module 208 determines the individual scores for each relevance category based on data included in the candidate user profile and the employment listing that is gathered by the data gathering module 204. For example, the individual score determination module 208 uses terms (e.g., words) included in the candidate user profile and the employment listing that relate to the relevance category. That is, the individual score determination module 208 uses a subset of the terms in the employment listing based on the respective relevance category and/or a subset of the terms in the candidate user profile based on the respective relevance category. For example, to determine an individual score for a relevance category based on the title of the employment listing, the individual score determination module 208 uses terms included in the title of the employment listing and terms included in the user's job title history listed on their user profile. As another example, the individual score determination module 208 determines the individual score for a relevancy category based on the desired skills included in the employment listing using terms included in the candidate user profile that list the user's skills and terms in the employment listing the desired skills for the open position.

In some embodiments, the individual score determination module 208 determines the individual score for a relevance category by matching terms from the candidate user profile and the employment listing. For example, the individual score determination module 208 compares the terms in the candidate user profile (e.g., terms describing the skills of the user) to the terms included in the employment listing (e.g., terms describing the desired skills of the employment listing) to determine a number and/or percentage of matching terms. A matching term may be a term that matches exactly or a near match, such as a different form or spelling of the same term, similar terms, etc. The individual score determination module 208 determines the individual score based on the determined number and/or percentage of matching terms. For example, the individual score determination module 208 assigns a higher individual score when a relatively high number or percentage of the terms match, whereas the individual score determination module 208 assigns a relatively lower score when a relatively lower number or percentage of the terms match.

In some embodiments, the individual score determination module 208 determines the individual score for a relevance category based on a determined distance between geographic locations associated with the candidate user profile and the employment listing. For example, the individual score determination module 208 determines a geographic location associated with the employment listing, such as the geographic location where the job is to be performed, and a geographic location from the candidate user profile indicating a geographic location at which the user lives. The individual score determination module 208 then determines a distance between the geographic location listed in the candidate user profile to the geographic location listed on the employment listing. The individual score determination module 208 determines the individual score based on the determined distance. For example, the individual score determination module 208 assigns a higher score when the distance is relatively shorter (e.g., the user lives close to the job), whereas the individual score determination module 208 assigns a lower score when the distance is relatively longer (e.g., the user lives far from the job).

The weight determination module 210 determines weights for the relevance categories. In some embodiments, the relevance score determination module 212 (described below) applies weights to the individual scores based on the estimated impact of their corresponding relevancy category to successfully finding a candidate to fill an open employment position. That is, the relevance score determination module 212 gives more consideration to relevancy categories that are determined to have a higher estimated impact on filling an employment position, and the relevance score determination module 212 gives less consideration to relevancy categories that are determined to have a lower estimated impact on filling an employment position.

The weight determination module 210 determines the weights for each relevancy category based on historical hiring data stored in the data storage 216. Historical hiring data includes previous employment listings and user profiles of users that were considered and/or filled the previous employment listings. The weight determination module 210 gathers the historical hiring data from the data storage 216 and uses the historical hiring data as training data to generate a model that generates weights for each of the relevancy categories.

The relevance score determination module 212 determines the relevancy score for a candidate user profile based on the individual scores for each relevancy category. For example, the relevance score determination module 212 applies the weights determined by the weight determination module 210 to its corresponding individual score. This results in a set of weighted individual scores. The relevance score determination module 212 applies the weights by multiplying the individual score by the weight, which results in a weighted individual score. The relevance score determination module 212 determines the relevancy score based on the set of weighted individual scores. For example, the relevance score determination module 212 determines a sum of the weighted individual score, which results in the relevance score. As another example, the relevance score determination module 212 determines the relevancy score by determining an average of the weighted individual scores.

The user profile selection module 214 uses the relevancy scores determined for the candidate user profiles to select a subset of the candidate user profiles, to which notifications regarding the employment listing can be sent. For example, the user profile selection module 214 can rank the candidate user profiles based on the relevancy scores and select a subset of the candidate user profiles that are ranked the highest, such as the top 10, 20, 30, etc., candidate user profiles. As another example, the user profile selection module 214 identifies a subset of the candidate user profiles that have a relevancy score above a threshold relevancy score.

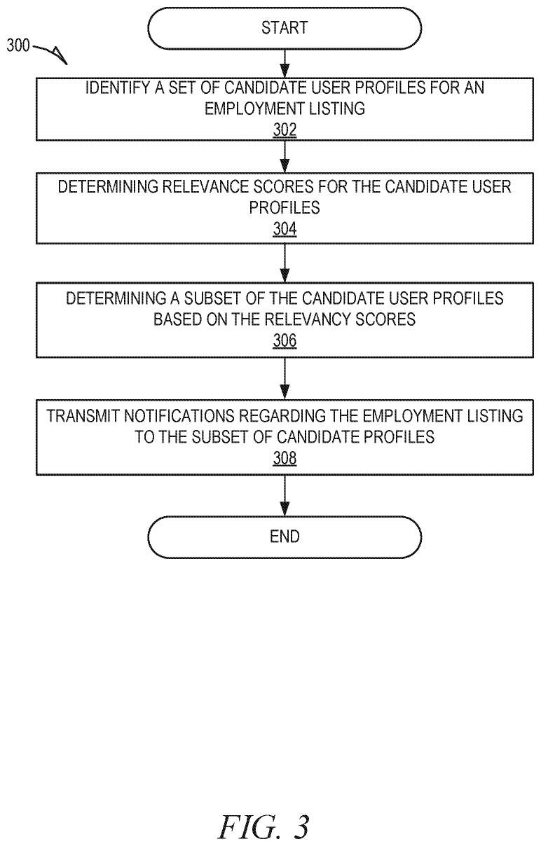

FIG. 3 is a flowchart showing an example method 300 of identifying a set of candidate user profiles, according to certain example embodiments. The method 300 may be embodied in computer readable instructions for execution by one or more processors such that the operations of the method 300 may be performed in part or in whole by the relevance system 108; accordingly, the method 300 is described below by way of example with reference thereto. However, it shall be appreciated that at least some of the operations of the method 300 may be deployed on various other hardware configurations and the method 300 is not intended to be limited to the relevance system 108.

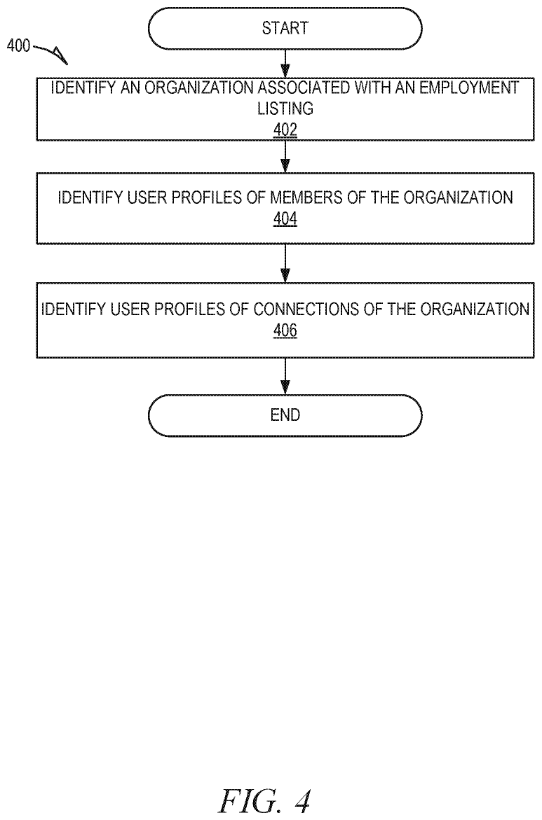

At operation 302, the candidate identification module 202 identifies a set of candidate user profiles for an employment listing. The candidate identification module 202 leverages the existing connections of the employees of an organization to identify the set of candidate user profiles. This operation is described in greater detail in relation to FIG. 4.

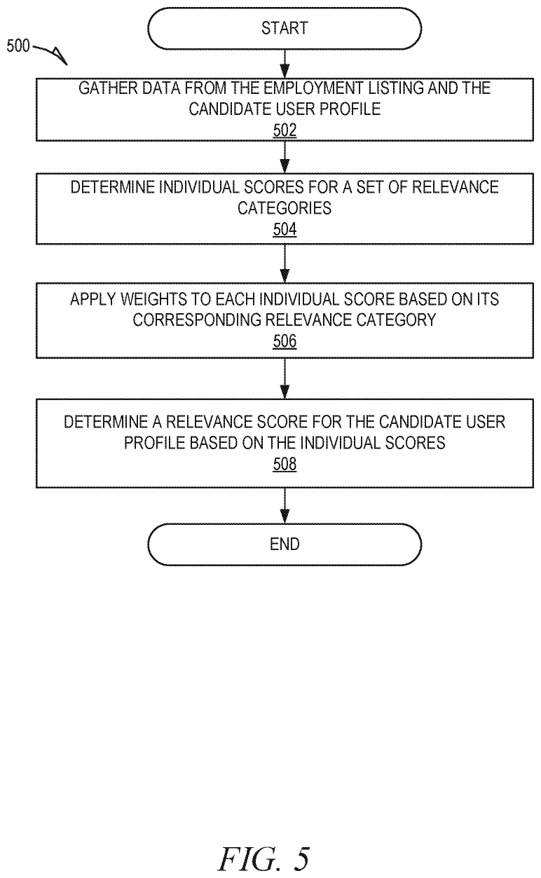

At operation 304, the relevance score determination module 212 determines relevance scores for the candidate user profiles. The relevance score determination module 212 determines the relevancy score for a candidate user profile based on a set of individual scores determined for the candidate user profile. Each individual score corresponds to a unique relevancy category. The resulting relevance scores are values (e.g., numerical values) that indicate an estimated relevance between each candidate user profile and the open employment listing. That is, each relevance score indicates how relevant the open position may be to the user corresponding to a candidate user profile and how well the user fits the qualifications of the employment listing. This operation is described in greater detail in relation to FIG. 5.

At operation 306, the user profile selection module 214 determines a subset of the candidate user profiles based on the relevancy scores. For example, the user profile selection module 214 ranks the candidate user profiles based on the relevancy scores and selects a subset of the candidate user profiles that are ranked the highest, such as the top 10, 20, 30, etc., candidate user profiles. As another example, the user profile selection module 214 identifies a subset of the candidate user profiles that have a relevancy score above a threshold relevancy score.

At operation 308, the relevance system 108 transmits notifications regarding the employment listing to the subset of candidate user profiles. For example, the notification describes the employment listing and includes a link to access additional information and/or apply to the position.

FIG. 4 is a flowchart showing an example method 400 of identifying a set of relevant user profiles, according to certain example embodiments. The method 400 may be embodied in computer readable instructions for execution by one or more processors such that the operations of the method 400 may be performed in part or in whole by the diversity relevance system 108; accordingly, the method 400 is described below by way of example with reference thereto. However, it shall be appreciated that at least some of the operations of the method 400 may be deployed on various other hardware configurations and the method 400 is not intended to be limited to the relevance system 108.

At operation 402, the candidate identification module 202 identifies an organization associated with an employment listing. For example, the candidate identification module 202 identifies the organization associated with the employment listing from the content of the employment listing. The content of the employment listing lists the name of the organization that posted the employment listing.

At operation 404, the candidate identification module 202 identifies user profiles of members of the organization. Member of the organization include employees of the organization. The data storage 216 maintains the user profiles and the candidate identification module 202 searches the data storage 216 based on the identified organization to identify that set of user profiles that are members of the organization.

At operation 406, the candidate identification module 202 identifies user profiles of connections of the organization. The candidate identification module 202 identifies the set of candidate user profiles based on the connections of the set of user profiles corresponding to the members of the organization. That is, the candidate identification module 202 identifies user profiles that are within a threshold degree of connection with the set of user profiles corresponding to the members of the organization. For example, the candidate identification module 202 identifies user profiles that are within one degree of connection of the set of candidate user profiles. As another example, the candidate identification module 202 identifies user profiles that are within two degrees of connection of the set of candidate user profiles.

FIG. 5 is a flowchart showing an example method 500 of determining a relevance score for a candidate user profile, according to certain example embodiments. The method 500 may be embodied in computer readable instructions for execution by one or more processors such that the operations of the method 500 may be performed in part or in whole by the relevance system 108; accordingly, the method 500 is described below by way of example with reference thereto. However, it shall be appreciated that at least some of the operations of the method 500 may be deployed on various other hardware configurations and the method 500 is not intended to be limited to the relevance system 108.

At operation 502, the data gathering module 204 gathers data from the employment listing and the candidate user profile. The data gathering module 204 gathers the data to generate relevance scores for the candidate user profiles. The data gathering module 204 gathers the data from the data storage 216. The data gathering module 204 may gather and provide all or subsets of the data included in the candidate user profiles and the employment listing to the other modules of the relevance system 108.

At operation 504, the individual score determination module 208 determines individual scores for a set of relevance categories. The individual score determination module 208 determines a set of individual scores for a candidate user profile based on the set of relevance categories. A relevance category is a unique predetermined signal for determining relevance between a candidate user profile and an open employment position. For example, a relevance category can be based on the title of the employment listing and the corresponding individual score indicates how well the title of the employment listing matches the job titles included in the employment history of the candidate user profile. As another example, a relevance category may be based on the location of the employment history and the corresponding individual score indicates how well the location of the employment listing matches a location of the user corresponding to the candidate user profile. As another example, a relevance category may be based on the desired skills listed in the employment listing and the corresponding individual score indicates how well the desired skills of the employment matches the listed skills of the user corresponding to the candidate user profile.

The individual score determination module 208 determines the individual scores for each relevance category based on data included in the candidate user profile and the employment listing that is gathered by the data gathering module 204. For example, the individual score determination module 208 uses terms (e.g., words) included in the candidate user profile and the employment listing that relate to the relevance category. That is, the individual score determination module 208 uses a subset of the terms in the employment listing based on the respective relevance category and/or a subset of the terms in the candidate user profile based on the respective relevance category. For example, to determine an individual score for a relevance category based on the title of the employment listing, the individual score determination module 208 uses terms included in the title of the employment listing and terms included in the user's job title history listed on their user profile. As another example, the individual score determination module 208 determines the individual score for a relevancy category based on the desired skills included in the employment listing using terms included in the candidate user profile that list the user's skills and terms in the employment listing the desired skills for the open position.

In some embodiments, the individual score determination module 208 determines the individual score for a relevance category by matching terms from the candidate user profile and the employment listing. For example, the individual score determination module 208 compares the terms in the candidate user profile (e.g., terms describing the skills of the user) to the terms included in the employment listing (e.g., terms describing the desired skills of the employment listing) to determine a number and/or percentage of matching terms. A matching term may be a term that matches exactly or a near match, such as a different form or spelling of the same term, similar terms, etc. The individual score determination module 208 determines the individual score based on the determined number and/or percentage of matching terms. For example, the individual score determination module 208 assigns a higher individual score when a relatively high number or percentage of the terms match, whereas the individual score determination module 208 assigns a relatively lower score when a relatively lower number or percentage of the terms match.

In some embodiments, the individual score determination module 208 determines the individual score for a relevance category based on a determined distance between geographic locations associated with the candidate user profile and the employment listing. For example, the individual score determination module 208 determines a geographic location associated with the employment listing, such as the geographic location where the job is to be performed, and a geographic location from the candidate user profile indicating a geographic location at which the user lives. The individual score determination module 208 then determines a distance between the geographic location listed in the candidate user profile to the geographic location listed on the employment listing. The individual score determination module 208 determines the individual score based on the determined distance. For example, the individual score determination module 208 assigns a higher score when the distance is relatively shorter (e.g., the user lives close to the job), whereas the individual score determination module 208 assigns a lower score when the distance is relatively longer (e.g., the user lives far from the job).

The weight determination module 210 determines weights for the relevance categories. In some embodiments, the relevance score determination module 212 (described below) applies weights to the individual scores based on the estimated impact of their corresponding relevancy category to successfully finding a candidate to fill an open employment position. That is, the relevance score determination module 212 gives more consideration to relevancy categories that are determined to have a higher estimated impact on filling an employment position, and the relevance score determination module 212 gives less consideration to relevancy categories that are determined to have a lower estimated impact on filling an employment position.

At operation 506, the relevance score determination module 212 applies weights to each individual score based on its corresponding relevance category. Each weight indicates the estimated impact of its corresponding relevancy category to successfully finding a candidate to fill an open employment position. By applying the weights, the relevance score determination module 212 gives more consideration to relevancy categories that are determined to have a higher estimated impact on filling an employment position, and the relevance score determination module 212 gives less consideration to relevancy categories that are determined to have a lower estimated impact on filling an employment position. The relevance score determination module 212 applies the weights to each individual score by multiplying the individual score by its corresponding weight. This process results in a set of weighted individual score.

At operation 508, the relevance score determination module 212 determines a relevance score for the candidate user profile based on the individual scores. For example, the relevance score determination module 212 determines a sum of the weighted individual score, which results in the relevance score. As another example, the relevance score determination module 212 determines the relevancy score by determining an average of the weighted individual scores.

### Software Architecture

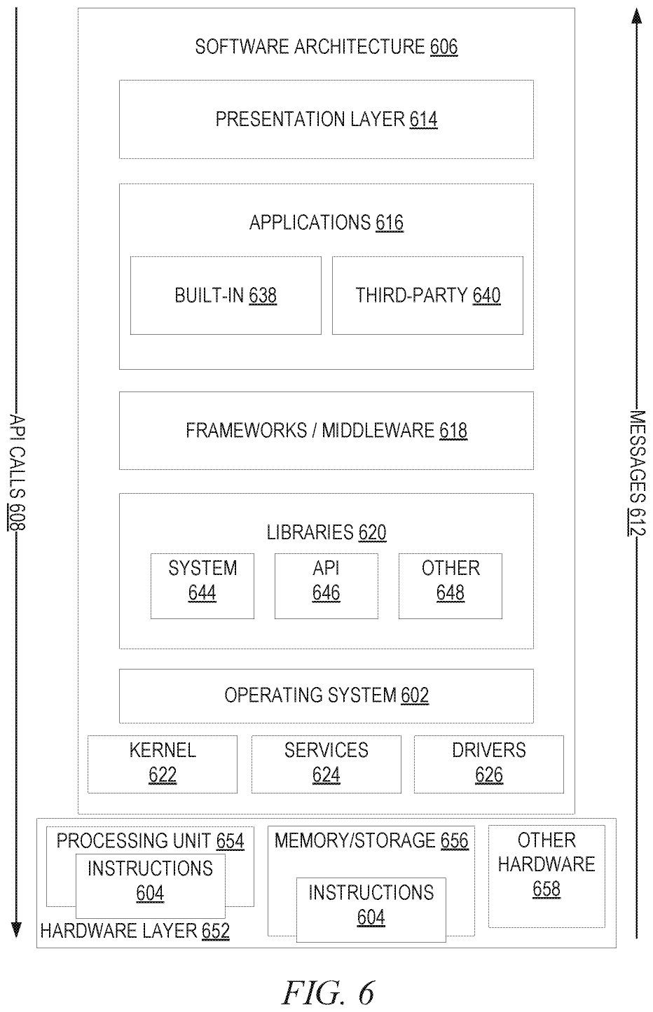

FIG. 6 is a block diagram illustrating an example software architecture 606, which may be used in conjunction with various hardware architectures herein described. FIG. 6 is a non-limiting example of a software architecture 606 and it will be appreciated that many other architectures may be implemented to facilitate the functionality described herein. The software architecture 606 may execute on hardware such as machine 700 of FIG. 7 that includes, among other things, processors 704, memory 714, and (input/output) I/O components 718. A representative hardware layer 652 is illustrated and can represent, for example, the machine 700 of FIG. 7. The representative hardware layer 652 includes a processing unit 654 having associated executable instructions 604. Executable instructions 604 represent the executable instructions of the software architecture 606, including implementation of the methods, components, and so forth described herein. The hardware layer 652 also includes memory and/or storage modules 656, which also have executable instructions 604. The hardware layer 652 may also comprise other hardware 658.

In the example architecture of FIG. 6, the software architecture 606 may be conceptualized as a stack of layers where each layer provides particular functionality. For example, the software architecture 606 may include layers such as an operating system 602, libraries 620, frameworks/middleware 618, applications 616, and a presentation layer 614. Operationally, the applications 616 and/or other components within the layers may invoke application programming interface (API) calls 608 through the software stack and receive a response such as messages 612 in response to the API calls 608. The layers illustrated are representative in nature and not all software architectures have all layers. For example, some mobile or special purpose operating systems may not provide a frameworks/middleware 618, while others may provide such a layer. Other software architectures may include additional or different layers.

The operating system 602 may manage hardware resources and provide common services. The operating system 602 may include, for example, a kernel 622, services 624, and drivers 626. The kernel 622 may act as an abstraction layer between the hardware and the other software layers. For example, the kernel 622 may be responsible for memory management, processor management (e.g., scheduling), component management, networking, security settings, and so on. The services 624 may provide other common services for the other software layers. The drivers 626 are responsible for controlling or interfacing with the underlying hardware. For instance, the drivers 626 include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 620 provide a common infrastructure that is used by the applications 616 and/or other components and/or layers. The libraries 620 provide functionality that allows other software components to perform tasks in an easier fashion than to interface directly with the underlying operating system 602 functionality (e.g., kernel 622, services 624, and/or drivers 626). The libraries 620 may include system libraries 644 (e.g., C standard library) that may provide functions such as memory allocation functions, string manipulation functions, mathematical functions, and the like. In addition, the libraries 620 may include API libraries 646 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 620 may also include a wide variety of other libraries 648 to provide many other APIs to the applications 616 and other software components/modules.

The frameworks/middleware 618 (also sometimes referred to as middleware) provide a higher-level common infrastructure that may be used by the applications 616 and/or other software components/modules. For example, the frameworks/middleware 618 may provide various graphical user interface (GUI) functions, high-level resource management, high-level location services, and so forth. The frameworks/middleware 618 may provide a broad spectrum of other APIs that may be used by the applications 616 and/or other software components/modules, some of which may be specific to a particular operating system 602 or platform.

The applications 616 include built-in applications 638 and/or third-party applications 640. Examples of representative built-in applications 638 may include, but are not limited to, a contacts application, a browser application, a book reader application, a location application, a media application, a messaging application, and/or a game application. Third-party applications 640 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 640 may invoke the API calls 608 provided by the mobile operating system (such as operating system 602) to facilitate functionality described herein.

The applications 616 may use built in operating system functions (e.g., kernel 622, services 624, and/or drivers 626), libraries 620, and frameworks/middleware 618 to create UIs to interact with users of the system. Alternatively, or additionally, in some systems, interactions with a user may occur through a presentation layer, such as presentation layer 614. In these systems, the application/component “logic” can be separated from the aspects of the application/component that interact with a user.

FIG. 7 is a block diagram illustrating components of a machine 700, according to some example embodiments, able to read instructions 604 from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 710 (e.g., software, a program, an application, an applet, an app, or other executable code) for causing the machine 700 to perform any one or more of the methodologies discussed herein may be executed. As such, the instructions 710 may be used to implement modules or components described herein. The instructions 710 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 700 capable of executing the instructions 710, sequentially or otherwise, that specify actions to be taken by machine 700. Further, while only a single machine 700 is illustrated, the term “machine” shall also be taken to include a collection of machines that individually or jointly execute the instructions 710 to perform any one or more of the methodologies discussed herein.

The machine 700 may include processors 704, memory/storage 706, and I/O components 718, which may be configured to communicate with each other such as via a bus 702. The memory/storage 706 may include a memory 714, such as a main memory, or other memory storage, and a storage unit 716, both accessible to the processors 704 such as via the bus 702. The storage unit 716 and memory 714 store the instructions 710 embodying any one or more of the methodologies or functions described herein. The instructions 710 may also reside, completely or partially, within the memory 714, within the storage unit 716, within at least one of the processors 704 (e.g., within the processor's cache memory), or any suitable combination thereof, during execution thereof by the machine 700. Accordingly, the memory 714, the storage unit 716, and the memory of processors 704 are examples of machine-readable media.

The I/O components 718 may include a wide variety of components to receive input, provide output, produce output, transmit information, exchange information, capture measurements, and so on. The specific I/O components 718 that are included in a particular machine 700 will depend on the type of machine. For example, portable machines such as mobile phones will likely include a touch input device or other such input mechanisms, while a headless server machine will likely not include such a touch input device. It will be appreciated that the I/O components 718 may include many other components that are not shown in FIG. 7. The I/O components 718 are grouped according to functionality merely for simplifying the following discussion and the grouping is in no way limiting. In various example embodiments, the I/O components 718 may include output components 726 and input components 728. The output components 726 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 728 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 718 may include biometric components 730, motion components 734, environmental components 736, or position components 738 among a wide array of other components. For example, the biometric components 730 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 734 may include acceleration sensor components (e.g., accelerometer), gravitation sensor components, rotation sensor components (e.g., gyroscope), and so forth. The environmental components 736 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 738 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 718 may include communication components 740 operable to couple the machine 700 to a network 732 or devices 720 via coupling 724 and coupling 722, respectively. For example, the communication components 740 may include a network interface component or other suitable device to interface with the network 732. In further examples, communication components 740 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 720 may be another machine or any of a wide variety of peripheral devices (e.g., a peripheral device coupled via a USB).

Moreover, the communication components 740 may detect identifiers or include components operable to detect identifiers. For example, the communication components 740 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 740 such as location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions 710 for execution by the machine 700, and includes digital or analog communications signals or other intangible medium to facilitate communication of such instructions 710. Instructions 710 may be transmitted or received over the network 732 using a transmission medium via a network interface device and using any one of a number of well-known transfer protocols.

“CLIENT DEVICE” in this context refers to any machine 700 that interfaces to a communications network 732 to obtain resources from one or more server systems or other client devices 102, 104. A client device 102, 104 may be, but is not limited to, mobile phones, desktop computers, laptops, PDAs, smart phones, tablets, ultra books, netbooks, laptops, multi-processor systems, microprocessor-based or programmable consumer electronics, game consoles, STBs, or any other communication device that a user may use to access a network 732.

“COMMUNICATIONS NETWORK” in this context refers to one or more portions of a network 732 that may be an ad hoc network, an intranet, an extranet, a virtual private network (VPN), a LAN, a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 732 or a portion of a network 732 may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions 710 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store instructions 710. The term “machine-readable medium” shall also be taken to include any medium, or combination of multiple media, that is capable of storing instructions 710 (e.g., code) for execution by a machine 700, such that the instructions 710, when executed by one or more processors 704 of the machine 700, cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors 704) may be configured by software (e.g., an application 616 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor 704 or other programmable processor 704. Once configured by such software, hardware components become specific machines 700 (or specific components of a machine 700) uniquely tailored to perform the configured functions and are no longer general-purpose processors 704. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor 704 configured by software to become a special-purpose processor, the general-purpose processor 704 may be configured as respectively different special-purpose processors (e.g., comprising different hardware components) at different times. Software accordingly configures a particular processor or processors 704, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may he achieved through signal transmission (e.g., over appropriate circuits and buses 702) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors 704 that are temporarily configured (e.g., by software) or permanently configured to perform the relevant operations. Whether temporarily or permanently configured, such processors 704 may constitute processor-implemented components that operate to perform one or more operations or functions described herein. As used herein, “processor-implemented component” refers to a hardware component implemented using one or more processors 704. Similarly, the methods described herein may be at least partially processor-implemented, with a particular processor or processors 704 being an example of hardware. For example, at least some of the operations of a method may be performed by one or more processors 704 or processor-implemented components. Moreover, the one or more processors 704 may also operate to support performance of the relevant operations in a “cloud computing” environment or as a “software as a service” (SaaS). For example, at least some of the operations may be performed by a group of computers (as examples of machines 700 including processors 704), with these operations being accessible via a network 732 (e.g., the Internet) and via one or more appropriate interfaces (e.g., an API). The performance of certain of the operations may be distributed among the processors 704, not only residing within a single machine 700, but deployed across a number of machines 700. In some example embodiments, the processors 704 or processor-implemented components may be located in a single geographic location (e.g., within a home environment, an office environment, or a server farm). In other example embodiments, the processors 704 or processor-implemented components may be distributed across a number of geographic locations.

“PROCESSOR” in this context refers to any circuit or virtual circuit (a physical circuit emulated by logic executing on an actual processor 704) that manipulates data values according to control signals (e.g., “commands,” “op codes,” “machine code,” etc.) and which produces corresponding output signals that are applied to operate a machine 700. A processor 704 may be, for example, a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC) or any combination thereof. A processor 704 may further be a multi-core processor having two or more independent processors 704 (sometimes referred to as “cores”) that may execute instructions 710 contemporaneously.

What is claimed is:

1. A method comprising:
identifying a set of candidate user profiles of an online network based on a set of user profiles of the online network that correspond to users that are members of a first organization, the set of candidate user profiles including at least one candidate user profile corresponding to a user that is not a member of the first organization;
for each candidate user profile:
determining a first score indicating a relevance level of the respective candidate user profile to an employment listing based on a first relevance category, the first score determined based on terms included in the employment listing and the respective candidate user profile that correspond to the first relevance category;
determining a second score indicating a level or relevance level of the respective candidate user profile to the employment listing based on a second relevance category, the second score determined based on terms included in the employment listing and the respective candidate user profile that correspond to the second relevance category;
applying a first weight to the first score, yielding, a first weighted score, the first weight determined based on historical hiring data and indicating a relative impact of the first relevance category on hiring;
applying a second weight to the second score, yielding, a second weighted score, the second weight determined based on the historical hiring data and indicating a relative impact of the second relevance category on hiring; and
determining a relevance score for the respective candidate user profile based on the first weighted score and the second weighted score;
selecting, based on the respective relevance scores for the set of candidate user profiles, a subset of the candidate user profiles; and
transmitting a notification regarding the employment listing to the subset of the candidate user profiles.

2. The method of claim 1, further comprising:
in response to determining that a geographic location of a first candidate user profile is outside of predetermined distance of a geographic location associated with the employment listing, removing the first candidate user profile from the set of candidate user profiles.

3. The method of claim 1, wherein selecting the subset of the candidate user profiles comprises:
ranking at least a first candidate user profile and a second candidate user profile based on the relevance score of the first candidate user profile and the relevance score of the second candidate user profile, the first candidate user profile being ranked higher than the second candidate user profile;
selecting, based on the ranking, the first candidate user profile for inclusion in the subset of the candidate user profiles.

4. The method of claim 1, wherein selecting the subset of the candidate user profiles comprises:
determining whether the respective relevance score for a first candidate user profile meets or exceeds a threshold relevance score.

5. The method of claim 1, wherein identifying the set of candidate user profiles comprises:
identifying a set of connected user profiles that are connections of a first user profile of the set of user profiles of the online network that correspond to users that are members of a first organization;
determining a subset of the set of connected user profiles that correspond to users that are not members of the first organization.

6. The method of claim 1, wherein determining the first score comprises:
determining a number of matching terms that are included in both the terms included in the employment listing that correspond to the first relevance category and the terms included in the respective candidate user profile that correspond to the first relevance category.

7. The method of claim 1, wherein determining the first score is further based on whether the respective candidate user profile indicates that the user corresponding to the respective candidate user profile is open to job opportunities.

8. A system comprising:
one or more computer processors; and
one or more computer-readable mediums storing instructions that, when executed by the one or more computer processors, cause the system to perform operations comprising:
identifying a set of candidate user profiles of an online network based on a set of user profiles of the online network that correspond to users that are members of a first organization, the set of candidate user profiles including at least one candidate user profile corresponding to a user that is not a member of the first organization;
for each candidate user profile:
determining a first score indicating a relevance level of the respective candidate user profile to an employment listing based on a first relevance category, the first score determined based on terms included in the employment listing and the respective candidate user profile that correspond to the first relevance category;
determining a second score indicating a level or relevance level of the respective candidate user profile to the employment listing based on a second relevance category, the second score determined based on terms included in the employment listing and the respective candidate user profile that correspond to the second relevance category;
applying a first weight to the first score, yielding, a first weighted score, the first weight determined based on historical hiring data and indicating a relative impact of the first relevance category on hiring;
applying a second weight to the second score, yielding, a second weighted score, the second weight determined based on the historical hiring data and indicating a relative impact of the second relevance category on hiring; and
determining a relevance score for the respective candidate user profile based on the first weighted score and the second weighted score;
selecting, based on the respective relevance scores for the set of candidate user profiles, a subset of the candidate user profiles; and
transmitting a notification regarding the employment listing to the subset of the candidate user profiles.

9. The system of claim 8, the operations further comprising:
in response to determining that a geographic location of a first candidate user profile is outside of predetermined distance of a geographic location associated with the employment listing, removing the first candidate user profile from the set of candidate user profiles.

10. The system of claim 8, wherein selecting the subset of the candidate user profiles comprises:
ranking at least a first candidate user profile and a second candidate user profile based on the relevance score of the first candidate user profile and the relevance score of the second candidate user profile, the first candidate user profile being ranked higher than the second candidate user profile;
selecting, based on the ranking, the first candidate user profile for inclusion in the subset of the candidate user profiles.

11. The system of claim 8, wherein selecting the subset of the candidate user profiles comprises:
determining whether the respective relevance score for a first candidate user profile meets or exceeds a threshold relevance score.

12. The system of claim 8, wherein identifying the set of candidate user profiles comprises:
identifying a set of connected user profiles that are connections of a first user profile of the set of user profiles of the online network that correspond to users that are members of a first organization;
determining a subset of the set of connected user profiles that correspond to users that are not members of the first organization.

13. The system of claim 8, wherein determining the first score comprises:
determining a number of matching terms that are included in both the terms included in the employment listing that correspond to the first relevance category and the terms included in the respective candidate user profile that correspond to the first relevance category.

14. The system of claim 1, wherein determining the first score is further based on whether the respective candidate user profile indicates that the user corresponding to the respective candidate user profile is open to job opportunities.

15. A non-transitory computer-readable medium storing instructions that, when executed by one or more computer processors of a computing system, cause the computing system to perform operations comprising:
identifying a set of candidate user profiles of an online network based on a set of user profiles of the online network that correspond to users that are members of a first organization, the set of candidate user profiles including at least one candidate user profile corresponding to a user that is not a member of the first organization;
for each candidate user profile:
determining a first score indicating a relevance level of the respective candidate user profile to an employment listing based on a first relevance category, the first score determined based on terms included in the employment listing and the respective candidate user profile that correspond to the first relevance category;
determining a second score indicating a level or relevance level of the respective candidate user profile to the employment listing based on a second relevance category, the second score determined based on terms included in the employment listing and the respective candidate user profile that correspond to the second relevance category;
applying a first weight to the first score, yielding, a first weighted score, the first weight determined based on historical hiring data and indicating a relative impact of the first relevance category on hiring;
applying a second weight to the second score, yielding, a second weighted score, the second weight determined based on the historical hiring data and indicating a relative impact of the second relevance category on hiring; and
determining a relevance score for the respective candidate user profile based on the first weighted score and the second weighted score;
selecting, based on the respective relevance scores for the set of candidate user profiles, a subset of the candidate user profiles; and
transmitting a notification regarding the employment listing to the subset of the candidate user profiles.

16. The non-transitory computer-readable medium of claim 15, the operations further comprising:
in response to determining that a geographic location of a first candidate user profile is outside of predetermined distance of a geographic location associated with the employment listing, removing the first candidate user profile from the set of candidate user profiles.

17. The non-transitory computer-readable medium of claim 15, wherein selecting the subset of the candidate user profiles comprises:
ranking at least a first candidate user profile and a second candidate user profile based on the relevance score of the first candidate user profile and the relevance score of the second candidate user profile, the first candidate user profile being ranked higher than the second candidate user profile;
selecting, based on the ranking, the first candidate user profile for inclusion in the subset of the candidate user profiles.

18. The non-transitory computer-readable medium of claim 15, wherein selecting the subset of the candidate user profiles comprises:
determining whether the respective relevance score for a first candidate user profile meets or exceeds a threshold relevance score.

19. The non-transitory computer-readable medium of claim 15, wherein identifying the set of candidate user profiles comprises:
identifying a set of connected user profiles that are connections of a first user profile of the set of user profiles of the online network that correspond to users that are members of a first organization;
determining a subset of the set of connected user profiles that correspond to users that are not members of the first organization.

20. The non-transitory computer-readable medium of claim 15, wherein determining the first score comprises:
determining a number of matching terms that are included in both the terms included in the employment listing that correspond to the first relevance category and the terms included in the respective candidate user profile that correspond to the first relevance category.
